(19) United States
(12) Patent Application Publication
(10) Pub. No.: US 2018/0053398 A1
(43) Pub. Date: Feb. 22, 2018

(54) Method and System which integrated with Doors Handle that Alert Against Forgetting Objects in the Car

(71) Applicant: Shareef Kharbawi, Gulis (IL)

(72) Inventor: Shareef Kharbawi, Gulis (IL)

(21) Appl. No.: 15/436,768

(22) Filed: Feb. 18, 2017

(30) Foreign Application Priority Data
Aug. 16, 2016 (IL) 247307

(51) Int. Cl. G08B 21/24; B60Q 5/00

(52) U.S. Cl. CPC G08B 21/24; B60Q 5/005

(57) ABSTRACT

A system for cars which is designed to alert the driver on the possibility to forget an object in the car which includes an activation unit and a warning unit. The activation unit includes a casing, a sensor unit, transceiver, an antenna, an electronic card and a battery. The warning unit includes a casing, transceiver, an antenna, an electronic card, a battery, indicator means, and a shutdown button. The activation unit mounted on the interior handle of the driver's door of the vehicle. The system or activation unit can be built into the handle of the driver's door.

### TECHNICAL FIELD

The present invention refers to a method and system which integrated with the interior handle of a door's car which designed to alert the drivers against forgetting objects in the car.

### BACKGROUND ART

There are many known incidents where a driver or a guardian forgot a baby in a car that result with sever endings. Also, there are many cases where people forget objects in the car, such as expensive equipment, bags with valuables, handbags with important documents, laptops with sensitive information and so-forth. There are many systems and accessories which designed to prevent situation in which the driver or guardian forget a baby or object in the car, but most of these include expensive components and awkwardly designed. In addition, the existing means designed in ways that reduce the possibility to use and activate them in an easy and simple routine. The present invention describes a methods and systems which integrated with the interior handle of a door's car and which designed to alert the drivers against forgetting objects in the car.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts the handle (200) located in the niche (300).

FIG. 2 depicts the front side (200A) of the handle (200).

FIG. 3 depicts the back side (200B) of the handle (200).

FIG. 4 schematically describes the system (1).

FIG. 5 schematically describes the activation unit (10) which includes a casing (11), sensor unit (12), transceiver (13), antenna (14), electronic card (15), battery (16) and indicator means (17).

FIG. 6 schematically describes the warning unit (100) which includes a casing (111), transceiver (113), antenna (114), electronic card (115), battery (116), indicator means (17) and shutdown button.

FIGS. 7 and 8 are perspective schematic description of the activation unit (10).

FIG. 9 is a perspective schematic description of the activation unit (10) where the inner part (11B) and the outer part (11A) are separately and connected by a rubber band (60).

FIG. 10 is a perspective schematic description of the system (1).

FIGS. 11 and 12 depict the handle (511).

### THE INVENTION

The main objective of the present patent application is to describe and provide a method and system for cars that is designed to alert the driver against forgetting object or a baby in the car. Another object of the present invention is to provide said method and system wherein part of said system is assembled on the interior handle of the driver door of the car.

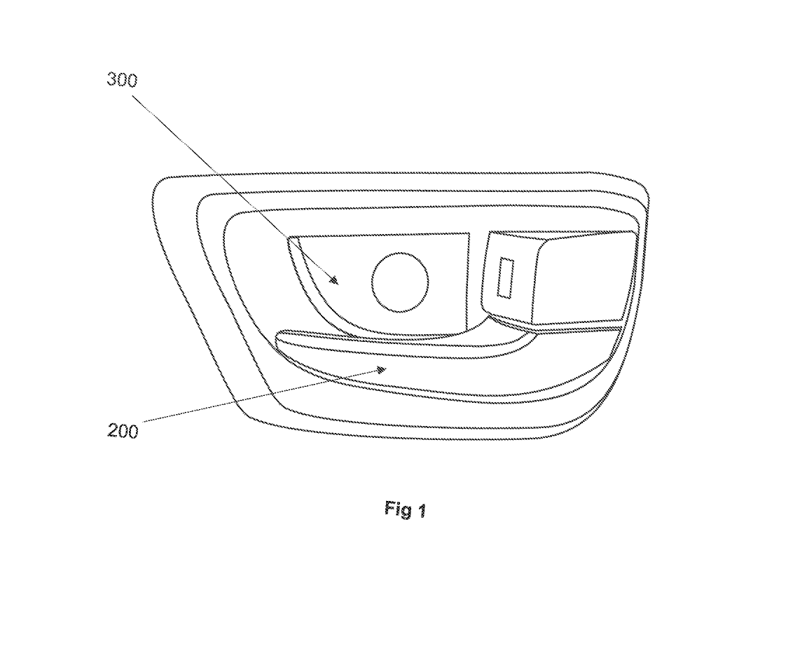

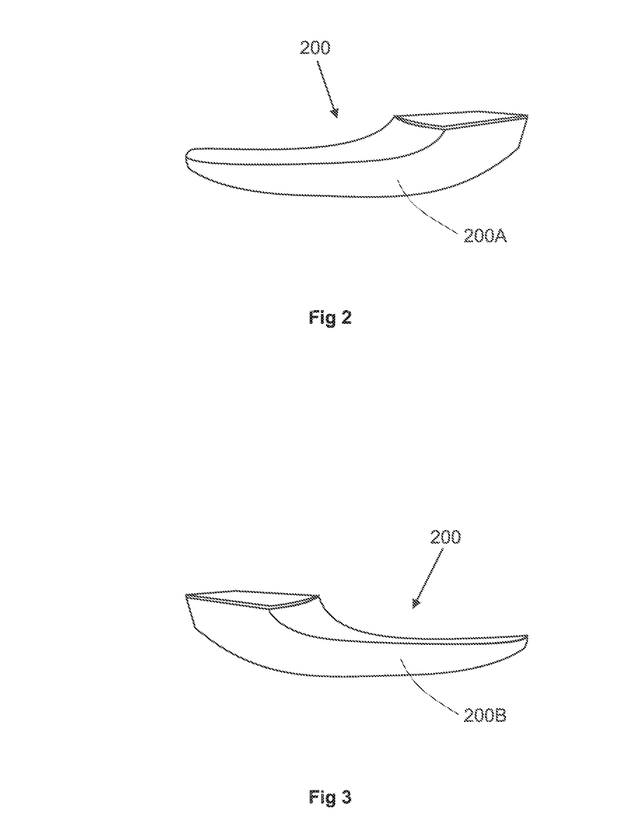

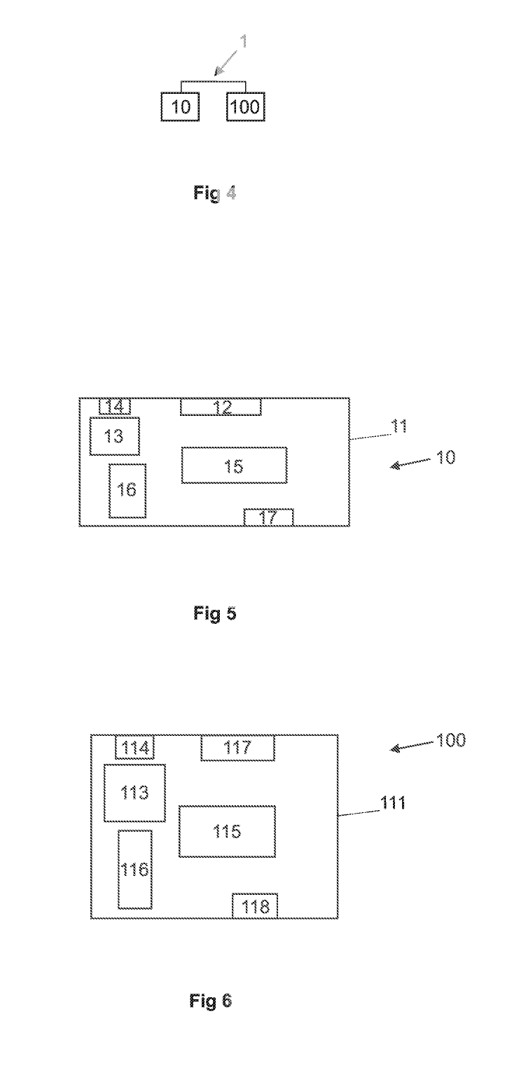

The system (1), subject matter of the present invention, includes an activation unit (10) and warning unit (100). The system (1) is designed to be assembled in the car in a way that the activation unit (10) is affixed or integrated on the interior handle (200) of the driver door. The interior handle is described in FIG. 1. FIG. 2 depicts the interior handle (200) and its front side (200A) which face the driver and FIG. 3 describes the interior handle (200) and its back side which face the niche (300) in which it is located. The system (1) is schematically described in FIG. 4. The activation unit (10) is described schematically in FIG. 5 and it includes a casing (11), sensor unit (11), transceiver (13), antenna (14), electronic card (15) and battery (16). The activation unit (10) may also include an indicator means (17).

The warning unit (100) is described schematically in FIG. 6 and it includes a casing (111), transceiver (113), antenna (114), electronic card (115), battery (116), indicator means (17) and shutdown button (118).

The casing (11) may be made as a compact molded plastic case in which the components of the activation unit (10) are positioned, and the same is as to the warning unit (100). The casing (11) may include several openings: an opening for the sensor unit (12), an opening for playing the voice alarm of the indicator means (17), an opening for replacing the battery (16), and an opening for the antenna, and the same as to the casing (111) of the warning unit (100).

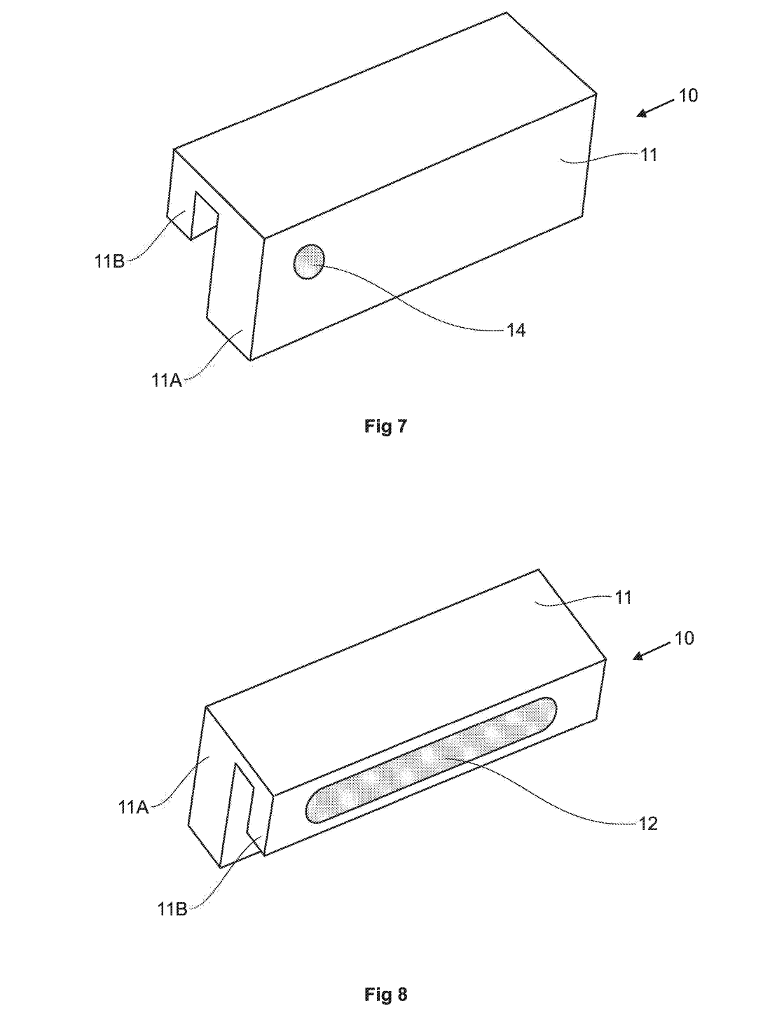

The activation unit (10) is designed to be assembled on the interior handle (200) of the driver door in the car. The structure of the activation unit's (10) casing (11) may be designed in a way that it will match to the shape of a standard interior handle (200). In addition, it is possible to use adapters to fit the grip of the activation unit (10) to a variety of designs and sizes of interior handles (200). The casing (11) includes an outer part (11A) and an inner part (11B). The outer part (11A) is adjacent to the front side (200A) of the handle (200). The inner part (11B) is adjacent to the back side (200B) of the interior handle (200), ie, to the side that facing the niche (300) in which the handle (200) is located. The casing (11) of the activation unit (10) may be designed in general in the shape as schematically illustrated in FIGS. 7 and 8.

The inner part (11B) of the casing (11) may include the sensor unit (12) whereas the outer part (11A) may include the other components. The fact that the casing is split into two parts, as described above, gives a great advantage to the system (1). First, the niche (300) in which the handle (200) is located is relatively small and may not accommodate a large enough casing that contains all the components of the activation unit (10). Therefore, most of the components are placed inside the outer part (11A) of the casing (11) that is not located in the niche (300). Secondly, as explained below, the system (1) is activated when the driver opens the door and his fingers exert a force on the back side (200B) of the handle (200), and because there inside located the inner part (11B) that includes the sensor unit (12), then the system (1) operates whenever the driver opens the car door, unnoticed and without the driver should give a thought to the possibility to forget something in the car.

Operation of the system (1): When the driver opens the car door at the end of the trip, then he puts his fingers into the niche (300) and exercises power over the back side (200B) of the handle (200), where located the inner part (11B) of the activation unit (10). The sensor unit (12) is located on the outside side of the inner part (11B), so that upon opening the door, in the above manner, the driver activates the sensor unit (12). In this case, the transceiver (13) via the antenna (14) sends a signal to the warning unit (100) and activates the indicator means (117) that plays indication sounds that alert the driver about the possibility that he may leave the vehicle and forget in it something important, which can be a baby, a briefcase or other important object.

The indicator means (117) can be electric buzzer or any other means that can alert. The system (1) can be programmed so that when the warning unit (100) starts to operate after receiving a signal from the activation unit (10), then it sends a returned signal to the activation unit (10). If no returned signal received, then the activation unit (10) activates its own indicator means (17). The concept of returned signal is used in cases that the warning unit (100) doesn't work. Due to the fact that there is an interest that the activation unit (10) will be small as possible so therefore the battery (16) may be relatively small, and it is desirable to use it only in case the warning unit (100) does not work. The battery (16) may be a miniature battery, and the battery (116) of the warning warning (100) can be larger, enough for a long time. The communication between the activation unit (10) and the warning unit (100) can be done by variety of types, for example, low-power RF. It is preferably that the communication of system (1) will be encoded in order that a system (1) of a particular car does not operate a system (1) of other vehicles nearby.

The inner part (11B) of the casing (11) of the activation unit (10) can be in the length of 3 cm, with a width of 1 cm and a thickness of 0.5 cm, and such size is sufficient to contain the sensor system (12). The outer part (11A) of the casing (11) of the activation unit (10) can be in the length of 3 cm, with a width of 2 cm and a thickness of 1 cm. The warning unit (100), for which there is no special limitation of size, can be in variety of sizes, about of 6 cm on 6 cm and a thickness of 3 cm, and such size can accommodate all its components including a large internal battery sufficient for long time.

The shutdown button (118) of the warning unit (100): when the driver opens the door, he activates the system (1) and the warning unit (100) operates and plays indication sounds. To stop the indicator means (117) it is necessary to press the shutdown button (118), that causing the driver to reach the place where the warning unit (100) is located.

The location of the warning unit (100): The user can purchase the system (1), assemble the activation unit (10) on the interior handle (200) of the driver's door and it is recommended to attach the warning unit (100) to the object the driver wish not to forget in the car, for example, the baby seat in the back seat. It is desirable to attach the warning unit (100) to the object that the driver wants to make sure that he will not forget in the car. For example, a baby chair, a bag or briefcase of valuable or important documents, a laptop with sensitive information, and a variety of things. The connection can be done by a pin, strip and a variety of fasteners.

Using the system (1): The system (1) can be a shelf product. The user can buy it and mount it in his car without any intervention in the vehicle systems. In addition, the system is activated automatically, that is because the activation unit (10) is mounted on the back side of the interior handle (200) of the driver's door, and whenever the driver gets out of the car he is naturally activates the handle and consequently activates the system (1). Also, the driver that hears the indication sound of the warning unit (100) is reminded to make sure not to forget anything and he must reach the object to which the warning unit (100) is attached and to shut it down by the shutdown button (118), and in this way the possibility that he will forget in the car that object is dramatically decreased.

The sensor unit (12) of the activation units (10) can be of a variety of sensors, such as: mechanical pressing sensor, touch sensor, an electromagnetic sensor and so-forth. In the case that the sensor unit (12) is of an electromagnetic sensor, it is possible that the sensor unit (12) will also include a separable permanent unit (512A) that be affixed permanently to the wall of the niche (300), so that it will be stationary and when the door handle (200) with the (electromagnetic) sensor unit (12) moves when opening the door, then the change in distance between these two parts triggers the sensor (12). It is highly desirable that all components of the system (1) will be with the quality and type that can durable and function well also in high temperatures that prevail in closed empty cars during the summer time, and sometimes along all the year.

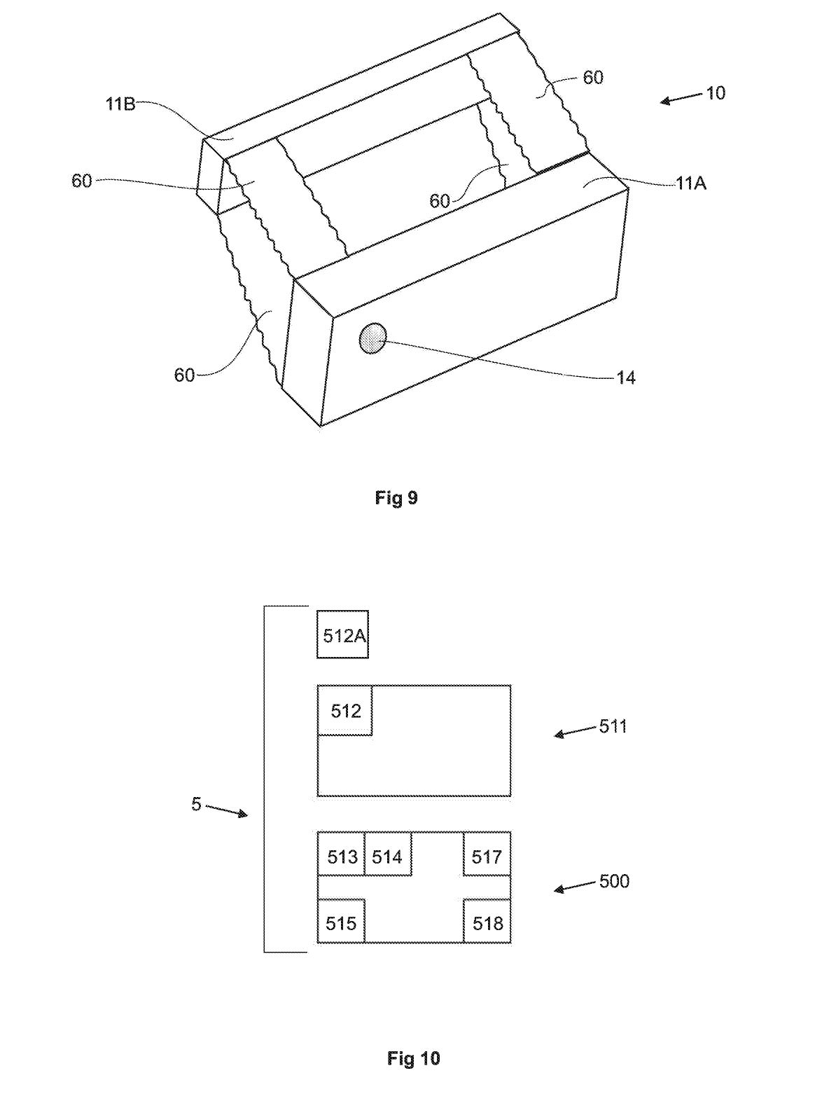

FIG. 9 describes a possibility of the casing (11) of the activation unit (10) in a way that the inner part (11B) and the outer part (11A) are separate and are connected by a rubber band (60) that enables to assemble the activation unit (10) on the interior handle (200) in a fast easy and tightening manner.

The second version of the system subject matter of the present invention is a system (5) that is built-in inside the interior handle (511). The system (5) can be applied by the vehicle manufacturer during the production of the vehicle. Alternatively, car manufacturers or anyone else can manufacture the interior handle (511) that includes the system (5) in a way that enable to replace the existing handle with the handle (511) that includes the system (5). In such case the handle (511) can be connected via the existing wiring of the driver's door wires.

The system (5) includes the interior handle (511) which is used as a casing that includes a sensor unit (512) and a warning unit (500). The warning unit can be separate or be built in the vehicle. Electronic card (515) manages the system (5) and said electronic card may be the central computer of the vehicle. The communication between the sensor unit (512) inside the handle (511) and the warning unit (500) may be wired or wirelessly via transmitters/receivers (513) and antennas (514), on the handle (511) and the warning unit (500). The handle (511) can receive voltage from the battery of the vehicle or by an internal battery, as well as the warning unit (500).

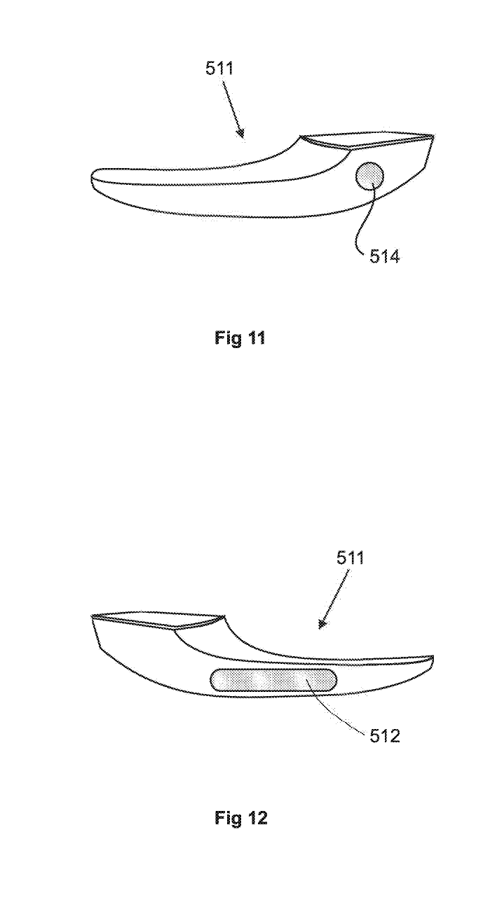

The indicator means (517) can be the horn of the vehicle or its signal lights system, and in such case the warning unit (500) may include a shutdown button (518) for sending a signal through the wire or transceiver for stopping the operation of the indicator means. FIG. 10 depicts schematically the system (5). FIG. 11 depicts the handle (511) with the antenna (514) and FIG. 12 depicts the handle (511) with the sensor unit (512).

The present invention also relates to a method to alert the vehicle user when he opens the car door on the possibility of forgetting object in the car, wherein said method includes the following means and steps: providing of the system (1) that includes the activation unit (10) and the warning Unit (100); assembling the activation unit (10) on the interior handle of the vehicle; Attaching the warning unit (100) to said object; wherein whenever the driver opens the door, then he runs the system (1).

The present invention also relates to additional method to alert the vehicle user when he opens the car door on the possibility of forgetting object in the car, wherein said method includes the following means and steps: providing of the system (5) that includes the handle (511) and the warning Unit (500); Attaching the warning unit (500) to said object; wherein whenever the driver opens the door, then he runs the system (5).

The systems (1) and (5) which are described above may include a cellular connection for transmitting the warnings also to mobile phones and/or devices with Internet or mobile communications.

What is claimed is:

1. A system for cars which is designed to alert the possibility to forget an object in the car, which comprises an activation unit and warning unit; wherein said activation unit includes a casing, a sensor unit, a transceiver, an antenna, an electronic card and a battery; wherein said warning unit includes a casing, a transceiver, an antenna, an electronic card, an indication means and a shutdown button; wherein said activation unit is designed to be assembled on the interior handle of the driver door of said car; wherein said casing of said activation unit includes outer part and inner part which contain the sensor unit; wherein said outer part is designed to be attached to the front side of said interior handle and wherein said inner part is designed to be attached to the back side of said interior handle.

2. A system for cars which is designed to alert the possibility to forget an object in the car, which comprises an interior handle for the driver door of said car and a warning unit; wherein said interior door serves as a casing that includes built-in a sensor unit and wired or wireless connection to system of said car or to said warning unit.

3. A method for cars which is designed to alert the possibility to forget an object in the car, which includes the following means and steps: providing a system that includes an activation unit and a warning Unit; assembling said activation unit, which includes a sensor unit, on the interior handle of said car; attaching said warning unit to said object; wherein whenever the driver opens the driver car door, then he runs the system.

4. A method for cars which is designed to alert the possibility to forget an object in the car, which includes the following means and steps: providing a system that includes a warning unit and an interior handle for car driver door which includes a built-in sensor unit; attaching said warning unit to said object; wherein whenever the driver opens the driver car door, then he activates said sensor unit and consequently he runs the system.
